(19) United States
(12) Patent Application Publication
(10) Pub. No.: US 2026/0061352 A1
(43) Pub. Date: Mar. 5, 2026

(54) CLEANABLE FILTER MEDIUM

(71) Applicant: DelStar Technologies, Inc., Alpharetta, GA (US)

(72) Inventors: Yasar Kiyak, Middletown, DE (US); Andrew Scarff, Middletown, DE (US); Andrew G. Platt, Middletown, DE (US)

(21) Appl. No.: 19/307,082

(22) Filed: Aug. 22, 2025

Related U.S. Application Data
(60) Provisional application No. 63/687,876, filed on Aug. 28, 2024.

(51) Int. Cl. B01D 39/08; B01D 41/00

(52) U.S. Cl. CPC B01D 39/086; B01D 41/00; B01D 2275/10; B01D 2275/205

(57) ABSTRACT

Cleanable filter media and filters are provided that are formed from extruded reticular materials, such as nettings, meshes, mattings, apertured films, apertured sheets and the like. A cleanable filter media comprises a first layer comprising an extruded reticular structure and a second layer in contact with the first layer and comprising an extruded reticular structure. The first and second layers may include holes, perforations or apertures that are misaligned with each other. The reticular structures may comprise an apertured polymer film or a netting. One or more of the layers may be electrically charged and/or may comprise charge additives or charge control agents. One or more of the layers may include a silicon-based coating. The cleanable filter media are less expensive to manufacture than conventional cleanable filter media and may have equivalent or improved performance characteristics.

### CROSS-REFERENCE TO RELATED APPLICATIONS

This application claims the benefit of U.S. Provisional Application Ser. No. 63/687,876, filed Aug. 28, 2024, the complete disclosure of which is incorporated herein by reference for all purposes.

### TECHNICAL FIELD

This description generally relates to cleanable, washable or reusable filter media formed from extruded polymer materials.

### BACKGROUND

Liquid and gas filters trap contaminants of many different types from the air, water, or others. Air filters, for example, typically include a filtration media comprising fibrous or porous materials which remove solid particulates, such as dust, pollen, mold, and bacteria from the air.

Two main types of air filtration devices include surface filters and depth filters. Depth filters are commonly employed in air filtration devices with a moderate to high efficiency, a low pressure drop, and a relatively high dust loading capacity. Depth filters generally employ various kinds of fibers that may be formed into a web or other nonwoven structure having tortuous paths between the fibers through which a gas stream, such as air, is passed. The particulate matter in the gas flowing through the paths in the web is retained on the upstream side of the web, or within the tortuous paths of the web due to the size of the particles relative to the paths' diameters.

Conventional residential and commercial air filters, such as HVAC filters, are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values depending on particle sizes within the air stream during testing. E3, E2, and E1 values refer to particulate efficiency at 3-10 microns, 1-3 microns and 0.3 to 1 micron, respectively.

Washable or cleanable filters can be rinsed with water or other chemicals and/or vacuumed to remove particle buildup, making them more economically friendly because they can be reused. Cleanable air filters are typically made out of woven polypropylene media, woven metal, metal mesh, monofilament woven fabric or knitted structures and foam media. The filter media is typically electrostatically charged in order to capture more particles. Currently marketed cleanable air filters typically have a lower pressure drop and lower efficiencies compared to single-use or disposable air filters. In addition, the initial upfront cost of such cleanable air filters is typically higher than single-use filters.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Cleanable filter media and filters are provided that are formed from extruded polymer materials, such as nettings, meshes, mattings, apertured films, apertured sheets and the like. The cleanable filter media are less expensive to manufacture than conventional cleanable filter media and may have equivalent or improved performance characteristics.

In one aspect, a cleanable filter media comprises a first layer comprising an extruded reticular structure and a second layer in contact with the first layer and comprising an extruded reticular structure.

In embodiments, the first and second layers each have one or more apertures and the apertures in the first layer are at least partially misaligned with the apertures in the second layer. In an exemplary embodiment, at least a portion of the apertures in the first layer are spaced away from the apertures in the second layer in a direction substantially parallel to the first and second layers such that the apertures in the first layer do not completely overlap with the apertures in the second layer. This provides a more tortuous path for fluid flowing through the filter media, thereby increasing its efficiency at capturing particles from the fluid.

In embodiments, the first and second layers comprise extruded polymeric nettings, mesh or mattings produced from polymer monofilaments or strands. The monofilaments or strands may be thermally bonded together where they cross to form a flexible, compression resistant matrix with a substantial amount of void space. The tight, low profile crisscross pattern of the netting distributes a controlled, predictable flow of fluid through the filter media.

Suitable materials for the strands include, but are not limited to, polyolefins (such as high density polyethylene (HDPE), polyethylene (PE), and low density polypropylene (LDPE)), nylon, polyesters (such as polybutylene terephthalate (PBT) and elastomeric (Hytrel), fluoropolymers (Halar and polyvinylidene fluoride (PVDF)), polyphenylene sulfide (PPS), acetal, elastomers, such as ethylene vinyl acetate (EVA), Noryl, conductive nylon, TPX, PVC, polypropylene (PP), metallocene PP, polylactic acid (PLA). thermoplastic polymers, polybutylene terephthalate (PBT), thermoplastic elastomer (TPE), biodegradable polymers, ionomers and combinations thereof. In an exemplary embodiment, the strands comprise HDPE, PP and combinations thereof.

In other embodiments, the first and second layers comprise extruded polymeric sheets or films that include apertures, pores or perforations. The apertures may be embossed in a pattern (such as circular, diamond shaped, hexagonal, oblong, triangular, rectangular, etc.) and then stretched until apertures form in the thinned out areas created by the embossing.

Suitable materials for the apertured films include, but are not limited to, high density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF), ethylene vinyl acetate (EVA), ionomers and combinations thereof. In an exemplary embodiment, the films comprise HDPE, PP and combinations thereof.

In embodiments, the filter media comprises a silicon-based coating on at least one of the first and second layers. The coating substantially improves the efficiency of the reticular structures at capturing contaminants, particularly contaminants in the E2 and E3 particle group range, without substantially compromising other important characteristics of the material, such as longevity, dust holding capacity, pressure drop and air permeability.

In embodiments, the silicone-based coating comprises a silicone compound having an add-on weight of about 0.5 gsm to about 10.0 gsm, or about 0.75 gsm to about 2 gsm, or about 1 gsm. The silicone-based coating may be at least about 0.5% of the total weight of the layer, or between about 0.5% and about 20%, or about 1% to about 15%.

In various embodiments, the silicone-based coating comprises a reactive silicone macroemulsion. The silicone emulsion may comprise, for example, dimethyl silicone emulsions, amino type silicone emulsions, organo-functional silicone emulsions, resin type silicone emulsions, film-forming silicone emulsions, or the like. In one embodiment, the reactive silicone macroemulsion comprises an amino functional polydimethylsiloxane and/or a polyethylene glycol monotridecyl ether. In an exemplary embodiment, the amino functional polydimethylsiloxane comprises about 30 to about 40 percent by weight of the coating. In embodiments, the polyethylene glycol monotridecyl ether comprises about 5 to about 10 percent by weight of the coating.

In some embodiments, the silicone-based coating further comprises an antistatic agent. The antistatic agent may comprise a cationic antistatic agent, an anionic antistatic agent, a quaternary antistatic agent, or a surfactant. The surfactant may comprise a non-rewetting thermodegradable surfactant/foaming agent.

In various embodiments, the silicone-based coating is applied by any suitable process including, but not limited to, spraying the layers with the silicone-based coating, dipping the layers in a vessel containing the silicone-based coasting, applying the silicone-based coating as a foam to the layer, utilizing a metering rod or other leveling device to apply the coating, delivering the coating on the layers with a coating head, such as a slot-die, or any combination of these techniques.

In certain embodiments, the silicone-based coating is applied by dipping or spraying. In an exemplary embodiment, the coating is sprayed onto the layer. Spray coating is particularly cost effective because it does not use as much water as other methods and is relatively easy to dry. In addition, spray coating is environmentally friendly because it uses less water and does not require the use of additional chemicals.

In embodiments, at least one of the first and second layers is electrically charged. The layer(s) can be electrostatically charged using triboelectric methods, corona discharge, electrostatic fiber spinning, hydro charging, charging bars or other known methods. In an exemplary embodiment, both the first and second layers are corona charged and, for example, may be negatively corona charged from about 10 kV to about 50 kV.

In embodiments, at least one of the first and second layers may comprise charge additives, charge adjuvants, a charge control agent (CCA), or any other agent added during the production of the layer to increase the charges generated on the layer. Suitable charge additives include, but are not limited to, metal salt of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, monoazo metal compound, alkyl acrylate monomers, alkyl methacrylate monomers, polytetrafluoroethylene, alkylene, arylene, aryleneialkylene, alkylenediarylene, oxydialkylene or oxydiarylene, polyacrylic and polymethacrylic acid compound, organic titanate, quaternary phosphonium trihalozincate salts, organic silicone complex compound, dicarboxylic acid compound, cyclic polyether or non-cyclic polyether and cyclodextrin, complex salt compound of the amine derivative, ditertbutylsalicyclic acid, potassium tetaphenylborate, potassium bis borate, sulfonamides and metal salts, cycloalkyl, alumina particles treated with silane coupling from group consisting of dimethyl silicone compound, azo dye, phthalic ester, quaternary ammonium salt, carbazole, diammonium and triammonium, hydrophobic silica and iron oxide, phenyl, substituted phenyl, naphthyl, substituted naphthyl, thienyl, alkenyl and alkylammonium complex salt compound, sodium dioctylsulfosuccinate and sodium benzoate, zinc complex compound, mica, monoalkyl and dialkyl tin oxides and urthene compound, metal complex of salicyclic acid compound, oxazolidinones, piperazines or perfluorinated alkane, lecigran MT, nigrosine, fumed silca, carbon black, para-trifluoromethyl benzoic acid and ortho-fluoro benzoic acid, poly(styrene-covinylpyridinium toluene sulfonate), methyl or butyltriphenyl complex aromatic amines, triphenylamine dyes and azine dyes, alkyldimethylbenzylammonium salts and combinations thereof.

In embodiments, the filter media further comprises a third layer in contact with the second layer and comprising an extruded reticular support structure. In some embodiments, the filter media may comprise four or more such layers, five or more such layers, six or more such layers or seven or more such layers. In an exemplary embodiment, each of the layers have one or more apertures and the apertures in each layer are at least partially misaligned with the apertures in the adjacent layers.

In embodiments, the filter media may comprise one or more pleats, folds, or creases extending across a surface of the filter media. In certain embodiments, the filter media is particularly useful as an air filter, such as an HVAC filter or the like. In various embodiments, the filter has a Minimum Efficiency Reporting Value or MERV of at least MERV 4, or at least about MERV 6, or MERV 8 according to ASHRAE 52.2.

In various embodiments, the filter has an E3 filtration efficiency of at least about 30%, or at least about 40%, or at least about 45%. In embodiments, the filter comprises a pressure drop of about 0.01 inch H²O to about 0.1 inch H²O at 180 fpm, or about 0.03 inch H²O to about 0.06 inch H²O at 180 fpm. In embodiments, each of the layers within the filter have an air permeability of about 500 cfm to about 2000 cfm at 125 Pa or about 700 cfm to about 1500 cfm at 125 Pa.

In embodiments, each of the layers in the filter media may have a different air permeability. Thus, in a filter media with three layers, the first layer has a first air permeability, the second layer has a second air permeability and the third layer has a third air permeability, wherein the first air permeability is greater than the second air permeability and the second air permeability is greater than the third air permeability. This creates a gradient density of air permeability throughout the filter media.

In another aspect, a cleanable filter media comprises an extruded reticular structure and a silicone-based coating on the support structure.

The extruded reticular structure may comprise extruded polymeric nettings, mesh or mattings produced from polymer monofilaments. The extruded reticular structure may comprise extruded polymeric sheets or films that include apertures, pores or perforations.

The silicone-based coating may comprise a silicone compound having an add-on weight of about 0.5 gsm to about 5.0 gsm, or about 0.75 gsm to about 2 gsm, or about 1 gsm. The silicone-based coating may be at least about 0.5% of the total weight of the layer, or between about 0.5% and about 20%, or about 1% to about 15%. The silicone-based coating is applied by any suitable process including, but not limited to, spraying, dipping, applying the silicone-based coating as a foam to the fibers, utilizing a metering rod or other leveling device to apply the coating, delivering the coating on the layers with a coating head, or any combination of these techniques.

In embodiments, the extruded reticular support structure may be electrically charged using triboelectric methods, corona discharge, electrostatic fiber spinning, hydro charging, charging bars or other known methods. In embodiments, the extruded reticular support structure may comprise one or more charge additives or charge control agents.

In another aspect, a filter media comprises a first layer having a first air permeability and a second layer in contact with the first layer and having a second air permeability. The first air permeability is greater than the second air permeability.

In embodiments, the filter media comprises a third layer in contact with the second layer and having a third air permeability. The third air permeability is less than the second air permeability.

In embodiments, the filter media comprises four or more such layers, five or more such layers, six or more such layers or seven or more such layers. Each of the layers has a different air permeability to create a gradient density through the filter media.

The layers of the filter media may comprise extruded polymeric nettings, mesh or mattings produced from polymer monofilaments. The layers may comprise extruded polymeric sheets or films that include apertures, pores or perforations.

One or more of the layers may comprise a silicone-based coating. One or more of the layers may be electrostatically charged. One or more of the layers may comprise one or more charge additives or charge control agents.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

The accompanying drawings, which are incorporated in and constitute a part of this specification, illustrate several embodiments of the disclosure and together with the description, explain the principles of the disclosure.

FIG. 1 is a cross-sectional view of a filter media comprising a reticular structure;

FIG. 2 is a cross-sectional view of a filter media comprising first and second layers of reticular structures;

FIG. 3 is a top view of a filter media comprising first and second reticular structures;

FIG. 4 is a cross-sectional view of a filter media comprising first, second and third reticular structures;

FIG. 5 is a top view of a netting for a filter media;

FIG. 6 is a top view of another embodiment of a netting for a filter media; and

FIG. 7 is a top view of another embodiment of a netting for a filter media.

FIG. 8 is a top view of an apertured film for a filter media;

FIG. 9 is a top view of another embodiment of an apertured film for a filter media;

FIG. 10 is a top view of another embodiment of an apertured film for a filter media;

FIG. 11 is a top view of another embodiment of an apertured film for a filter media;

FIG. 12 is a top view of another embodiment of an apertured film for a filter media; and

FIG. 13 is a top view of a filter media comprising first and second layers of apertured films.

### DETAILED DESCRIPTION OF THE EMBODIMENTS

This description illustrates exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Cleanable filter media and filters are provided that are formed from extruded polymer materials, such as nettings, meshes, mattings, apertured films, apertured sheets and the like. A cleanable or washable filter media as used herein means any filter media that can be rinsed with a fluid, such as water or other cleaning fluids, and/or vacuumed with a suction device to remove a substantial portion of particles that have been collected by the filter media during use. A sufficient volume of particles is removed during the cleaning process to allow the filter media to be reused without a substantial drop in efficiency and/or a substantial increase in pressure drop.

The filter media may be particularly useful in the following industries: aerospace, aftermarket products, beverage dispensers, coalescing, computers, data centers, electronics, food service, NVACR, ice machines, industrial enclosures, injection molding, marine, medical, military, portable cooling, power generation, PTAC, reach-in coolers, refrigerated display cases, telecom, transportation, wind turbines, municipal, waste water, automotive, power generation, industrial process fluids, semiconductor, petroleum/chemical refining, pulp and paper, food and beverage, medical/pharmaceutical, general manufacturing and the like. The filter media may be used in a variety of filters including, but not limited to, gas filters, air filters, liquid filters, pleated filters, RO filters, outer sleeves for cylindrical filters, face masks, CPAP filters, vacuum bags, cabin air filters, HVAC furnace filters, residential and commercial air filters, gas turbine, and compressor air intake filters, reverse osmosis filters, pre-filters, panel filters, intake filters, filter presses, rotary drum filters, a clean-in-place (CIP) filter, bag filters, cartridge filters or the like.

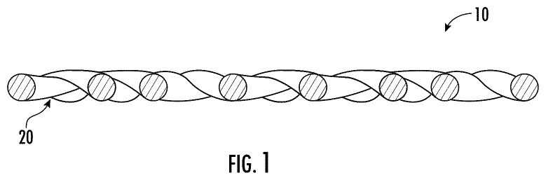

Referring now to FIG. 1, a filter media 10 comprises an extruded reticular structure 20. The extruded reticular structure 20 may comprise a layer, film, sheet, mesh or the like that comprises one or more apertures, holes, pores, perforations or the like, such as a netting, mesh, matting, apertured film, apertured sheet and the like.

In one embodiment, the extruded reticular structure 20 comprises a polymeric netting or mesh. The netting may be formed from any suitable method such as extrusion, co-extrusion, bi-component, and elastomeric nettings. In an exemplary embodiment, the netting is formed from a mono-extrusion or co-extrusion process. Generally, suitable methods for making the extruded netting includes extruding a polymeric blend composition through dies with reciprocating or rotating parts to form the netting configuration. This creates cross machine direction strands that cross the machine direction strands, which flow continuously. After the extrusion, the netting is then typically stretched in the machine direction using a differential between two sets of nip rollers. A suitable netting is available commercially and is marketed under the trademark Naltex®.

Suitable materials for the netting include, but are not limited to, polyolefins (such as high density polyethylene (HDPE), polypropylene (PP), and low density polypropylene (LDPE)), nylon, polyesters (such as polybutylene terephthalate (PBT) and elastomeric (Hytrel), fluoropolymers (Halar and polyvinylidene fluoride (PVDF)), polyphenylene sulfide (PPS), Acetal, elastomers, such as ethylene vinyl acetate (EVA), Noryl, conductive nylon, TPX, PVC, polyethylene (PE), metallocene PP, polylactic acid (PLA). thermoplastic polymers, polybutylene terephthalate (PBT), thermoplastic elastomer (TPE), biodegradable polymers, ionomers and combinations thereof. In an exemplary embodiment, the netting comprises HDPE, PP and combinations thereof.

The netting may include additional materials for color, UV stabilizers, antistatics, flame retardant additives, antimicrobial additives, such as silver, triclosan, heavy metals and the like.

Each layer of netting may have a basis weight of about 30 gsm to about 500 gsm or about 50 gsm to about 200 gsm or about 75 gsm to about 125 gsm. The netting may be designed to have an air permeability of about 500 cfm to about 2000 cfm at 125 Pa, or about 700 cfm to about 1500 cfm at 125 Pa. In some embodiments (discussed below), the air permeability of each layer may differ.

The netting comprises a plurality of apertures or holes. The apertures may comprise pores or perforations. The apertures may have any suitable shape, such as circular, diamond shaped, elliptical, trilobal, square, rod, hexagonal, teardrop, oblong, triangular, rectangular, or a combination thereof. In an exemplary embodiment, the apertures have a substantially diamond shape. The apertures 150 may have a size of at least about 50 microns, or at least about 150 microns, preferably at least about 250 microns.

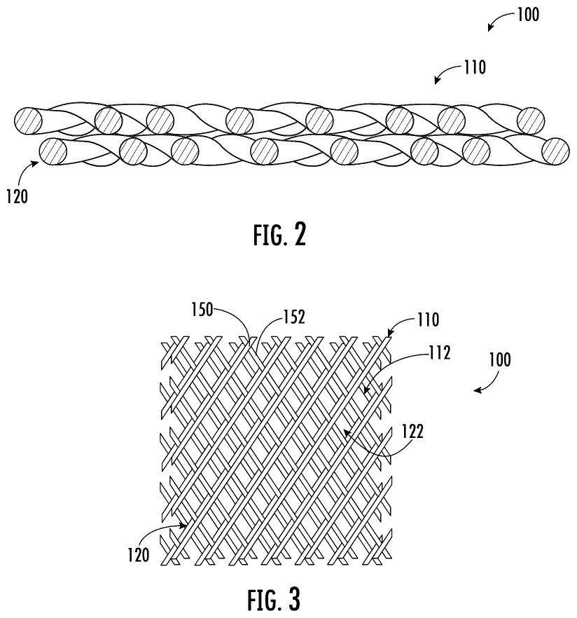

Referring now to FIGS. 2 and 3, a filter media 100 comprises a first layer 110 comprising an extruded reticular structure, such as netting or mesh, with a plurality of apertures 112 and a second layer 120 comprising an extruded reticular structure, such as netting or mesh with a plurality of apertures 122. First layer 110 is in contact with second layer 120. First and second layers 110, 120 may be bonded to each other in any suitable manner, such as thermal bonding, ultrasonic bonding, mechanical bonding and the like.

The apertures 112, 122 are formed from a first series of strands 150 extending in one direction and a second series of strands 152 extending in a generally crosswise or transverse direction. The first and second sets of strands 150, 152 are extruded polymeric elongate members which cross and intersect during extrusion to form the net-like structure. The strands could also be formed of extruded strands that are knitted together rather than crossed during extrusion. The strands may have any suitable thickness, such as about 6 mils to about 250 mils, or about 10 mils to about 100 mils, or about 15 mils to about 50 mils.

In certain embodiments, the apertures 112 in first layer 110 are misaligned with the apertures 122 in second layer 120 (see FIG. 3). Thus, at least one portion of each aperture 112 in first layer 110 does not directly overlie an aperture 122 in second layer 120 such that at least one portion of each aperture 112 in first layer 110 overlies one or more strands 152 of second layer 120 (and vice versa). This provides a more tortuous path for fluid flowing through the filter media, thereby increasing its efficiency at capturing particles from the fluid.

In an exemplary embodiment, the apertures 112 in first layer 110 are laterally spaced from the apertures 122 in second layer 120 such that a portion of each aperture 112 in first layer 110 overlies one or more stands 152 of second layer 122 (i.e., the apertures in each layer are laterally spaced from each other in the plane parallel to the layers).

In some embodiments, the strands are made of the same material. In other embodiments, the first set of strands 150 are made of a different material than the second set of strands 152. For example, the netting may include 10 to 90 wt. % of the material of the first set of strands 150 and 10 to 90 wt. % of the material of the second set of strands 152. In still other embodiments, the netting may include 45 to 55 wt. % of the material of strands 150 and 45 to 55 wt. % of the material of strands 152.

The thickness of the strands 150, 152 is preferably about 0.006 inches to about 0.500 inches. The strand density is preferably less than about 100 strands per inch, or less than about 50 strands per inch, or less than about 30 strands per inch or less than about 20 strands/inch. The strands may be formed at an angle of about 30 to about 105 degrees, or about 70 to about 90 degrees, or about 75 degrees. In an exemplary embodiment, the apertures formed by the strands are symmetrical although it will be recognized that the apertures may be non-symmetrical in certain embodiments.

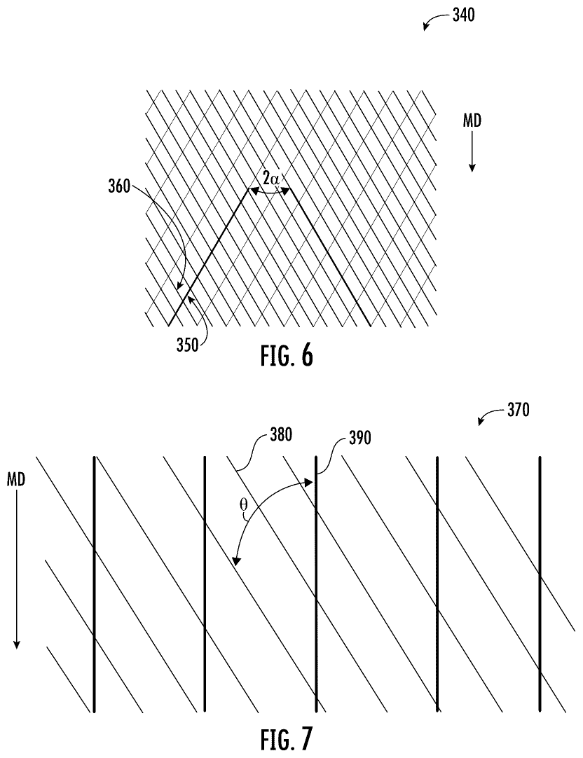

FIGS. 5-7 show several examples of nettings that can be used with the filter media described herein. FIG. 5 illustrates an example of a symmetrical netting 300 wherein both sets of strands 310, 320 are at an angle to the machine direction (MD) and have the same number and size. FIG. 6 illustrates an example of an asymmetrical netting 340 wherein both sets of strands 350, 360 are at an angle to the MD, but are different in number and/or size. As shown, strands 350 are thicker than strands 360. FIG. 7 illustrates another example of a non-symmetrical netting 370 wherein one set of strands 380 is an at angle to the MD and the other set of strands 390 is substantially parallel to the MD. The strands 380, 390 may have the same number and thickness or they may have a different number and/or thickness.

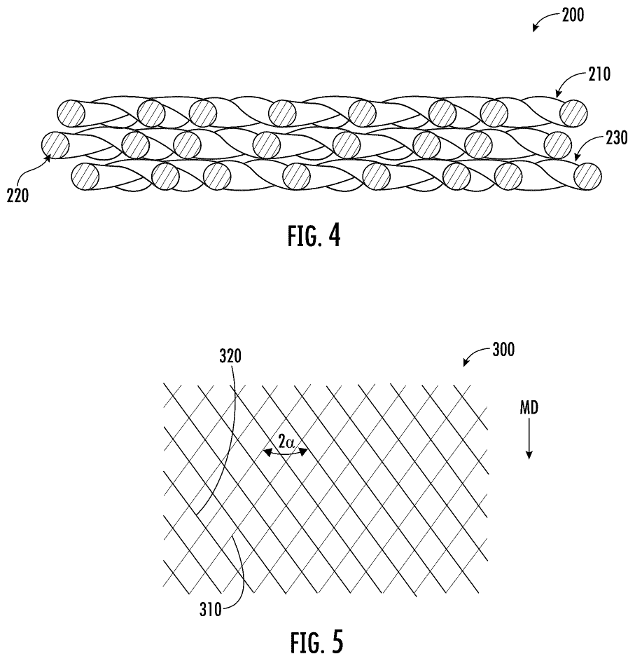

Referring now to FIG. 4, a filter media 200 comprises a first layer 210 comprising an extruded reticular structure, a second layer 220 comprising an extruded reticular structure and a third layer 230 comprising an extruded reticular structure. First layer 210 is in contact with second layer 220 and second layer 220 is in contact with third layer 230. First, second and third layers 210, 220, 230 may be bonded to each other any suitable manner, such as thermal bonding, ultrasonic bonding, mechanical bonding and the like. In certain embodiments, the apertures in first layer 210 are misaligned with the apertures in second layer 220 and the apertures in second layer 220 are misaligned with the apertures in third layer 230.

It will be recognized that the filter medias described herein may comprise more than three layers, more than four layers, more than five layers, more than six layers, or seven layers or more. Each of the layers in the filter media comprise an extruded reticular structure comprises a plurality of apertures, holes, pores or the like. In an exemplary embodiment, the apertures in each layer are misaligned with the apertures in the adjacent layers. Sheets of multiple types can be combined and one or more layers may be used. Sheets of different materials can be combined. In certain embodiments, the sheets have a plurality of pleats extending across a surface of the polymer layer.

In another embodiment, structure 20 comprises a polymeric extruded apertured film. The apertured film may be formed from any suitable method such as extrusion, co-extrusion, bi-component, and elastomeric nettings. In an exemplary embodiment, the film is formed from a mono-extrusion or co-extrusion process. The apertured films may be configured for use in many applications, including finger bandages, surgical gowns, drapes, masks, teeth whitening strips, hydrogel scrims, nasal support materials, electrode support products, filters, food processing, packaging and textile applications, agricultural products, food packaging, such as cheese production netting and many more.

The apertures can be provided in a variety of patterns having one or more shapes. The apertures may be embossed in a pattern (such as circular, diamond shaped, elliptical, trilobal, square, rod, hexagonal, oblong, triangular, rectangular, or a combination thereof) and then stretched until apertures form in the thinned out areas created by the embossing. A suitable apertured film is available commercially and is marketed under the trademark Delnet®.

Suitable materials for the apertured films include, but are not limited to, high density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF), Halar (ECTFE), ethylene vinyl acetate (EVA), ionomers and combinations thereof. In an exemplary embodiment, the films comprise HDPE, PP and combinations thereof.

In some embodiments, the apertured films may further include additional binder materials to facilitate lamination. Suitable materials for a binder include, but are not limited to, ethylene vinyl acetate (EVA), ionomer, such as those commercially available under the trade names SURLYN™ and MAEC™, or combinations thereof.

The film may have an open area of about 15% to about 65% (i.e., the percentage of the film that includes apertures or pores). The apertures or pores may each have an area of about 2500 microns² to about 4 mm². The thickness of the film may be about 2 to 30 mils. Each layer of the films may have a basis weight of about 5 gsm to about 60 gsm. The films may have an air permeability of about 500 cfm to about 1500 cfm at 125 Pa. In certain embodiments (discussed below), the air permeability of each layer may differ.

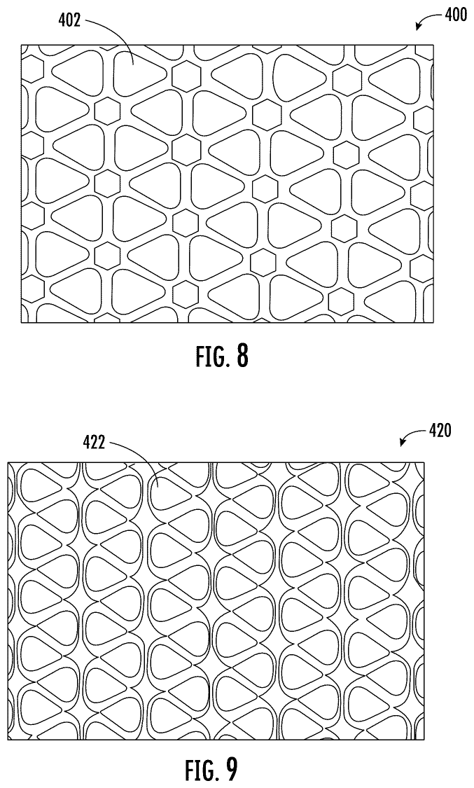

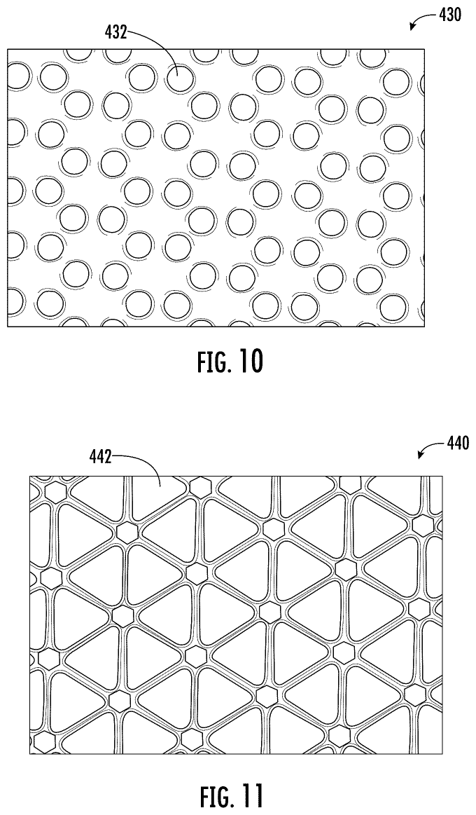

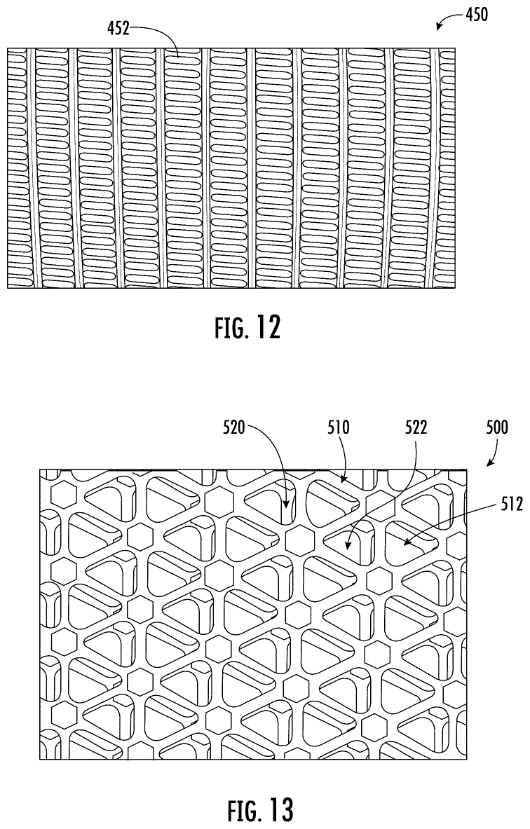

FIGS. 8-12 show several examples of apertured films that can be used with the filter media described herein. As shown in FIG. 8, in one embodiment, reticular structure 20 may comprise an apertured film 400 comprising triangular-shaped apertures 402 formed therein. FIG. 9 illustrates an apertured film 420 having tear-drop shaped apertures 422 formed therein. FIG. 10 illustrates an apertured film 430 having substantially round-shaped apertures 432 formed therein. FIG. 11 illustrates an apertured film 440 having substantially triangular-shaped apertures 442 formed therein. FIG. 12 illustrates an apertured film 450 having substantially elliptical-shaped apertures 452 formed therein.

In certain embodiments, the filter media may comprise two or more layers of apertured films, or three or more layers, or four or more layers, five or more layers, or seven or more layers. Referring to FIG. 13, a filter media 500 comprises first and second layers 510, 520 of apertured films each having apertures 512, 522 formed therein. As shown, the apertures 512 in first layer 510 are misaligned with the apertures 522 in second layer 520. Thus, at least a portion of the solid film portion of layer 510 overlies at least a portion of the apertures 522 in second layer 520 (and vice versa).

In some embodiments, the apertured films may compromise additives, such as nucleating agents, UV stabilizers, coloring pigments and the like.

In certain embodiments, each layer of the filter media may comprise different materials so long as the layers are at least somewhat compatible with each other. Each layer of the filter media may also comprise multiple materials. For example, a first layer of the media may comprise a material having an AB configuration and the second layer may comprise a material having a BAB configuration.

In certain embodiments, some of the layers of the filter media may comprise different air permeabilities. The air permeability of each layer may, for example, increase or decrease across the layers to form a gradient density of air permeabilities across the filter media. For example, in one embodiment, the filter media comprises a first layer having a first air permeability and a second layer in contact with the first layer and having a second air permeability. The first air permeability is greater than the second air permeability. In another embodiment, the filter media comprises a third layer in contact with the second layer and having a third air permeability. The third air permeability is less than the second air permeability.

In one such embodiment, the layer of filter media closest to air entry has a higher air permeability than the layer of filter media furthest from the air exit. Each succeeding layer (from air entry to exit) may have a lower air permeability such that the air permeability decreases as air flows through the filter media. For example, in one embodiment, the filter media comprises at least three layers, with the first layer being closest to air entry, the third layer being closest to air exit and the second layer disposed therebetween. The first layer may have an air permeability of about 1000 cfm to about 2000 cfm at 125 Pa, the second layer may have an air permeability of about 750 cfm to about 1500 cfm at 125 Pa and the third layer may have an air p permeability of about 500 cfm to about 1000 cfm at 125 Pa.

In certain embodiments, one or more of the layers of the filter media (either a netting or an apertured film) may be electrostatically charged such that, for example, contaminants are captured both with mechanical and electrostatic filtration. The fibers can be electrostatically charged using triboelectric charging, corona discharge, electrostatic fiber spinning, hydro charging, charging bars or other known methods. One suitable method for triboelectric charging is described in U.S. Pat. No. 9,074,301, the entire disclosure of which is hereby incorporated by reference herein for all purposes.

In an exemplary embodiment, the layers of the filter media are corona charged. The term “corona charged” refers to the process of exposing one or more of the layers of the filter media to an ACD and/or DC corona-charging device, such that charges are places on the extruded reticular layers. In one embodiment, one or more of the layers are negatively charged at about 10 kV to about 50 kV or about 30 kV.

One or more different layers of the filter media may comprise charge additives, charge adjuvants or a charge control agent (CCA), or any agent added during the production of a charged layer to increase the charges generated on the layer. The CCA's include but are not limited to metal salt of aluminum or magnesium, lead zirconate titanate, potassium niobate, lithium niobate, lithium tantalate, sodium tungstate, unsaturated carboxylic acid or derivative thereof, unsaturated epoxy monomer or silane monomer, maleic anhydride, monoazo metal compound, alkyl acrylate monomers, alkyl methacrylate monomers, polytetrafluoroethylene, alkylene, arylene, aryleneialkylene, alkylenediarylene, oxydialkylene or oxydiarylene, polyacrylic and polymethacrylic acid compound, organic titanate, quaternary phosphonium trihalozincate salts, organic silicone complex compound, dicarboxylic acid compound, cyclic polyether or non-cyclic polyether and cyclodextrin, complex salt compound of the amine derivative, ditertbutylsalicyclic acid, potassium tetaphenylborate, potassium bis borate, sulfonamides and metal salts, cycloalkyl, alumina particles treated with silane coupling from group consisting of dimethyl silicone compound, azo dye, phthalic ester, quaternary ammonium salt, carbazole, diammonium and triammonium, hydrophobic silica and iron oxide, phenyl, substituted phenyl, naphthyl, substituted naphthyl, thienyl, alkenyl and alkylammonium complex salt compound, sodium dioctylsulfosuccinate and sodium benzoate, zinc complex compound, mica, monoalkyl and dialkyl tin oxides and urthene compound, metal complex of salicyclic acid compound, oxazolidinones, piperazines or perfluorinated alkane, lecigran MT, nigrosine, fumed silca, carbon black, para-trifluoromethyl benzoic acid and ortho-fluoro benzoic acid, poly(styrene-covinylpyridinium toluene sulfonate), methyl or butyltriphenyl complex aromatic amines, triphenylamine dyes and azine dyes, alkyldimethylbenzylammonium salts and combinations thereof. A more complete description of suitable CCAs that may be used can be found in U.S. Pat. No. 10,571,137, which is incorporated herein by reference in its entirety for all purposes.

Alternatively, the charge adjuvant may belong to the group of organic triazine compounds or oligomers with at least one additional nitrogen-containing group, as disclosed for example in WO 97/07272, in the following referred to as “triazine based charge adjuvant” or “TB-CA”.

In some embodiments, the charge adjuvant may comprise a hindered amine. Typically, the hindered amine comprises derivatives of tetramethylpiperidine. Preferably, the hindered amine belongs to the group of hindered amine (light) stabilizers (HA(L)S). More preferably, the charge adjuvant is selected from the group comprising the HA(L)S substances having the following CAS registry numbers: CAS 52829-07-9, CAS 71878-19-8, CAS 106990-43-6, CAS 63843-89-0, CAS 192268-64-7, CAS 90751-07-8, CAS 193098-40-7, CAS 79720-19-7, CAS 106917-30-0, CAS 167078-06-0, CAS 131290-28-3, CAS 109423-00-9, CAS 124172-53-8, CAS 199237-39-3, CAS 91788-83-9, CAS 64022-61-3, CAS 107119-91-5, CAS 100631-43-4, CAS 115055-30-6, CAS 100631-44-5, CAS 64338-16-5, CAS 85099-51-0, CAS 202483-55-4, CAS 76505-58-3, CAS 136504-96-6, CAS 71029-16-8, CAS 96204-36-3, CAS 130277-45-1, CAS 229966-35-2, CAS 85099-51-0, CAS 147783-69-5, CAS 154636-12-1, CAS 84214-94-8, CAS 99473-08-2, CAS 164648-93-5, CAS 164648-93-5 and CAS 42774-15-2. A particularly preferred HALS compound is poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]] (CAS 71878-19-8, Chimassorb® 944) or 1,6-Hexanediamine, N,N′-bis(2,2,6,6-tetramethyl-4-piperidinyl)-polymer with 2,4,6-trichloro-1,3,5-triazine, reaction products with N-butyl-1-butanamine and N-butyl-2,2,6,6-tetramethyl-4-piperidinamine (CAS 192268-64-7, Chimassorb® 2020).

In some embodiments, one or more of the layers may include a nucleating agent, or an agent added to a polymer melt which promotes crystallization of a semi-crystalline polymer from the melt. In an exemplary embodiment, the nucleating agent is a clarifier. The nucleating agent may be selected from a group consisting of benzoate salt, a sorbitol acetate, a rosin based nucleating agent, a carboxylic acid amide, a salt of an organophosphorous acid and mixtures thereof. A more complete description of suitable nucleating agents can be found in U.S. application Ser. No. 18/036,369, filed Nov. 10, 2020, the complete disclosure of which is incorporated herein by reference in its entirety for all purposes.

In certain embodiments, one or more of the extruded reticular layers in the filter media may include a silicone-based coating. In an exemplary embodiment, the silicone-based coating includes a silicone compound diluted in water or other suitable fluid such that the silicone compound comprises at least about 1 percent by weight of the coating, or at least about 2 percent by weight of the coating. In an exemplary embodiment, the silicone compound comprises about 5-10% by the weight of the coating. In an exemplary embodiment, the silicone compound comprises a silicone material, a surfactant, and water. The silicone and surfactant may together comprise about 5-10% weight of the overall coating.

The applicant has discovered that directly coating the reticular structures (as opposed to applying the coating to an outer surface of the already-formed filter media) with the silicone-based coating described herein substantially improves the efficiency of such filters at capturing contaminants, particularly contaminants in the E2 and E3 particle group range. In addition, this coating does not substantially compromise other important characteristics of the filters, such as cost, longevity, dust holding capacity, and the pressure drop or air permeability of the filter.

In embodiments, the silicone-based coating comprises a reactive silicone macroemulsion. Silicone emulsions are insoluble silicones substantially evenly dispersed in water with the aid of a surfactant. The silicone emulsion may comprise, for example, dimethyl silicone emulsions, amino type silicone emulsions, organo-functional silicone emulsions, resin type silicone emulsions, film-forming silicone emulsions or the like. In an exemplary embodiment, the reactive silicone macroemulsion comprises an amino functional polydimethylsiloxane and/or a polyethylene glycol monotridecyl ether. In embodiments, the amino functional polydimethylsiloxane comprises about 30 to about 40 percent by weight of the coating. In embodiments, the polyethylene glycol monotridecyl ether comprises about 5 to about 10 percent by weight of the coating. A more complete description of suitable silicone-based coatings can be found in commonly assigned co-pending U.S. Application No. 18,464,484, filed Sep. 14, 2022 and U.S. Provisional patent application Ser. No. 18/560,813, filed Mar. 4, 2024, the complete disclosures of which are incorporated herein by reference for all purposes.

In embodiments, the silicone-based coating further comprises an antistatic agent. The antistatic agent may comprise a surfactant. The surfactant may comprise a non-rewetting thermodegradable surfactant/foaming agent.

In various embodiments, the dry add-on weight of the silicone-based coating is about 0.5 gsm to about 10 gsm, or about 1 gsm to about 5 gsm or about 1 gsm. The add-on weight was measured by weighing the extruded polymer layer prior to application of the silicone-based coating and then weighing the layer again after the coating was applied to the layer and dried thereon.

The silicone-based coating is applied by any suitable process including, but not limited to, spraying the layers with the silicone-based coating, dipping the layers in a vessel containing the silicone-based coasting, applying the silicone-based coating as a foam to the layers, utilizing a metering rod or other leveling device to apply the coating, delivering the coating on the layers with a coating head, such as a slot-die, or any combination of these techniques.

In certain embodiments, the silicone-based coating is applied by dipping or spraying.

In certain embodiments, the reticular structures discussed herein may be included as part of a filter device that traps or absorbs contaminants, such as an air filter for home and commercial air filtration (e.g., HVAC). In some embodiments, the filter media may be scored, pleated, or folded into a pleated filter. The pleats may be formed by various conventional pleating operations that include, but are not limited to, bar, rotary, and star gear pleating operations.

Conventional home and commercial air filters are typically rated by the filter's ability to capture particles between about 0.3 and 10 microns. This rating, referred to as a Minimum Efficiency Reporting Value or MERV is developed by the American Society of Heating, Refrigerating and Air Conditioning Engineers (ASHRAE). The MERV ratings range from 1-16, with higher values indicating higher efficiencies at trapping specific types of particles. It is also common to compare efficiency values in depending on particle sizes within the air stream during testing. E3, E2 and E1 values refer to particulate efficiency at 3-10 microns, 1-3 microns, and 0.3 to 1 micron, respectively.

The MERV rating of the filter media discussed herein will vary based on many factors, including the types and sizes of fibers used in the filter media, the width of the filter media, the number and size of pleats (if any), and the like. Likewise, the pressure drop across the filter media will also depend on many factors, including those mentioned above.

In certain embodiments, the filter media comprising reticular structures that are electrically charged and coated with the silicon-based coating described herein may be used to manufacture pleated air or HVAC filters with at least a minimum efficiency rating (MERV) of about MERV 4 or about MERV 6 according to ASHRAE 52.2. In some embodiments, the MERV rating is MERV 8.

In embodiments, the filter comprises an E3 filtration efficiency of at least about 30%, or at least about 40%, or at least about 45%. In embodiments, the filter comprises a pressure drop of about 0.01 inch H²O to about 0.1 inch H²O at 180 fpm, or about 0.03 inch H²O to about 0.06 inch H²O at 180 fpm. In embodiments, each of the layers within the filter media have an air permeability of about 500 cfm to about 2000 cfm at 125 Pa or about 700 cfm to about 1500 cfm at 125 Pa.

Other types of filters that may be developed with the nonwoven material disclosed herein include conical filter cartridges, square end cap filter cartridges, pocket filters, V-bank compact filters, panel filters, flat cell filters, pleated or unpleated bag cartridge filters, and the like.

### Examples

The applicant manufactured and tested a number of different filter media. The testing measured the pressure drop across each filter media at 180 fpm in inches H²O and the initial fractional efficiency percentage of the filter media for three separate particle groups: (1) E1 particles having a size of about 0.3 microns to 1 micron; (2) E2 particles having a size of about 1 micron to 3 microns; and (3) E3 particles having a size of about 3 microns to about 10 microns. All MERV ratings (based on flat sheet fractional efficiency testing) reported here are predicted MERV ratings.

In a first experiment, Applicant manufactured and tested the following samples: (1) Sample A: three layers of polypropylene apertured films each having a plurality of substantially elliptical apertures with an area of about 1311×906 microns for each aperture (see FIG. 12). Each single layer had a thickness of 10 mils and a basis weight of 38.7 gsm. The three layers combined had a basis weight of about 116 gsm. The boss count was about (MD) 21/inch and (CD) 12/inch. The air permeability was 1100 cfm at 125 Pa.; (2) Sample B: two layers of polypropylene apertured films each having a plurality of substantially elliptical apertures having an area of about 875×354 microns for each aperture (see FIG. 12), a basis weight for each layer of 22.7 gsm and a combined basis weight of 45.3 gsm; (3) Sample A-Charged: the three layer Sample A described above and corona negatively charged at 30 kV; (4) Sample B-Charged: the two layer Sample B described above and corona negatively charged at 30 kV; and (5) Charged Woven Black Media: comprising a layer of polypropylene honeycomb woven fabric containing an inherent electrostatic charge and manufactured by Permatron®. The woven fabric had a thickness of about 70 mils and an air permeability of about 1230 cfm at 125 Pa.

The result of this testing is shown below in TABLE 1.

TABLE 1

| | Pressure Drop | | | | Predicted |
|---|---|---|---|---|---|
| | (inch H²O) at | E1 | E2 | E3 | MERV |
| Samples | 180 fpm | (%) | (%) | (%) | Rating |
| Sample A | 0.03 | 0.0 | 3.0 | 16 | 4 |
| Sample B | 0.06 | 0.0 | 8.7 | 19.2 | 4 |
| Sample A Charged | 0.03 | 0.0 | 3.5 | 19.4 | 4 |
| Sample B Charged | 0.06 | 0.0 | 12.4 | 25.4 | 4 |
| Charged Black Woven | 0.03 | 0.0 | 1.6 | 15.0 | 4 |
| Media | | | | | |

As shown above, Sample A Charged demonstrated the same pressure drop and an improved efficiency at capturing E2 and E3 particles as the charged black woven media. Sample B also demonstrated a higher efficiency at capturing E2 and E3 particles with a slightly higher pressure drop than the charged black woven media. The uniform pore structure of Samples A and B enable washability and reusability. In addition, Samples A and B are substantially less expensive to manufacture because: (1) Samples A and B are extruded rather than woven; and (2) Samples A had a much lower basis weight (116 gsm for Sample A and 45.3 for Sample B) compared to the basis weight of 280 of the charged woven media.

The applicant conducted a second test of different filter media. In this test, Sample A, Sample B and the Charged Black Woven Media were the same as in the above example. In addition, applicant tested: (1) Sample A coated with the silicon-based coating described above (dry add-on amount for each layer was about 1 gsm); (2) Sample B coated with the silicon-based coating described above (dry add-on amount for each layer was about 1 gsm); (3) Sample A both coated with the silicon-based coating and electrostatically charged as described above; (4) Sample B both coated with the silicon-based coating and electrostatically charged as described above. The result of this testing is shown below in TABLE 2.

TABLE 2

| | Pressure Drop | | | | Predicted |
|---|---|---|---|---|---|
| | (inch H²O) at | E1 | E2 | E3 | MERV |
| Samples | 180 fpm | (%) | (%) | (%) | Rating |
| Sample A | 0.03 | 0.0 | 3.0 | 16 | 4 |
| Sample B | 0.06 | 0.0 | 8.7 | 19.2 | 4 |
| Sample A-Coated | 0.05 | 0.0 | 3.2 | 31 | 5 |
| Sample B-Coated | 0.06 | 0.0 | 6.1 | 38 | 6 |
| Sample A- Coated and | 0.05 | 0.0 | 6.2 | 45.5 | 6 |
| Charged | | | | | |
| Sample B-Coated and | 0.06 | 0.0 | 11.5 | 49.3 | 6 |
| Charged | | | | | |
| Charged Black Woven | 0.03 | 0.0 | 1.6 | 15.0 | 4 |
| Media | | | | | |

Coating and charging the filter media significantly increased the efficiency at capturing E2 and E3 particles. As shown in TABLE 2, Sample A Coated and Charged had an efficiency of capturing E3 particles of 45.5% and Sample B Coated and Charged had an efficiency of capturing E3 particles of 49.3% (compared to 15% for the charged black woven media). In addition, Sample A Coated and Charged had an efficiency of capturing E2 particles of 6.2% and Sample B Coated and Charged had an efficiency of capturing E3 particles of 11.5% (compared to 1.6% for the charged black woven media).

The predicted MERV ratings of the samples were also improved over the woven media. Coating alone increased the predicted MERV rating of Sample A to MERV 5 and Sample B to MERV 6. The coated and charged media both had a predicted rating of MERV 6. Thus, both the silicone-based coating and the electrostatic charging independently increased the particle capture efficiency and the predicted MERV rating of the filter media.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a cleanable filter media comprising a first layer comprising an extruded reticular structure and a second layer in contact with the first layer and comprising an extruded reticular structure.

A second embodiment is the first embodiment, wherein the first and second layers each comprise one or more apertures, wherein the apertures in the first layer are at least partially misaligned with the apertures in the second layer.

A third embodiment is any combination of the first two embodiments, wherein the first and second layers each comprise solid portions surrounding the apertures and wherein at least a portion of the solid portions of the first layer overlie at least a portion of the apertures in the second layer.

A 4^{th} embodiment is any combination of the first 3 embodiments, wherein the first and second layers each comprise an extruded polymer film having one or more apertures.

A 5^{th} embodiment is any combination of the first 5 embodiments, wherein the first and second layers comprise a material selected from the group consisting of high density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF), ethylene vinyl acetate (EVA), ionomers and combinations thereof.

A 6^{th} embodiment is any combination of the first 5 embodiments, wherein the first and second layers comprise PP, HDPE and combinations thereof.

A 7^{th} embodiment is any combination of the first 6 embodiments, wherein the apertures have an area of about 2500 microns² to about 4 mm².

An 8^{th} embodiment is any combination of the first 7 embodiments, wherein each of the first and second layers has a basis weight of about 5 gsm to about 60 gsm.

A 9^{th} embodiment is any combination of the first 8 embodiments, wherein each of the first and second layers has a thickness of about 2 to about 30 mils.

A 10^{th} embodiment is any combination of the first 9 embodiments, wherein the first and second layers each comprise a netting comprising strands.

An 11^{th} embodiment is any combination of the first 10 embodiments, wherein the first and second layers comprise a material selected from the group consisting of high density polyethylene (HDPE), polyethylene, polypropylene (PP), metallocene PP, polylactic acid (PLA). thermoplastic polymers, Nylon, polybutylene terephthalate (PBT), thermoplastic elastomer (TBE), polyphenylene sulfide (PPS), polyvinylidene fluoride (PVDF), ethylene vinyl acetate (EVA), ionomers and combinations thereof.

A 12^{th} embodiment is any combination of the first 11 embodiments, wherein the first and second layers comprise PP.

A 13^{th} embodiment is any combination of the first 12 embodiments, wherein the netting comprises apertures having a size of about 100 microns to about 500 microns.

A 14^{th} embodiment is any combination of the first 13 embodiments, wherein the netting has a basis weight of about 30 gsm to about 500 gsm.

A 15^{th} embodiment is any combination of the first 14 embodiments, further comprising a third layer in contact with the second layer and comprising an extruded reticular structure.

A 16^{th} embodiment is any combination of the first 15 embodiments, wherein at least one of the first and second layers is coated with a silicone-based coating.

A 17^{th} embodiment is any combination of the first 16 embodiments, wherein the coating comprises a silicone compound having an add-on weight of about 0.5 gsm to about 10.0 gsm.

An 18^{th} embodiment is any combination of the first 17 embodiments, wherein the add-on weight is about 0.75 gsm to about 2.0 gsm.

A 19^{th} embodiment is any combination of the first 18 embodiments, wherein the silicone compound is at least about 1% by weight of a total weight of the layer.

A 20^{th} embodiment is any combination of the first 19 embodiments, wherein the silicone-based coating comprises an amino functional polydimethylsiloxane.

A 21^{ss} embodiment is any combination of the first 20 embodiments, wherein the silicone-based coating comprises polyethylene glycol monotridecyl ether.

A 22^{nd} embodiment is any combination of the first 21 embodiments, wherein the silicone-based coating is applied to the first or second layers by one of dip coating, rod coating, foam coating, slot-die coating, spray coating and combinations thereof.

A 23^{rd} embodiment is any combination of the first 22 embodiments, wherein at least one of the first and second layers is electrically charged.

A 24^{th} embodiment is any combination of the first 23 embodiments, wherein at least one of the first and second layers is corona charged.

A 25^{th} embodiment is any combination of the first 24 embodiments, wherein at least one of the first and second layers comprises charge additives.

A 26^{th} embodiment is any combination of the first 25 embodiments, wherein at least one of the first and second layers comprises a charge control agent.

A 27^{th} embodiment is any combination of the first 26 embodiments, wherein the first and second layers comprise one or more pleats.

A 28^{th} embodiment is any combination of the first 27 embodiments, wherein the first and second layers have an air permeability of about 500 cfm to about 2000 cfm at 125 Pa.

A 29^{th} embodiment is any combination of the first 28 embodiments, wherein the air permeability is about 700 cfm to about 1500 cfm at 125 Pa.

A 30^{th} embodiment is any combination of the first 29 embodiments, wherein the first layer has a first air permeability, the second layer has a second air permeability and the third layer has a third air permeability, wherein the first air permeability is greater than the second air permeability and the second air permeability is greater than the third air permeability.

In another aspect, an air filter is providing comprising any combination of the above 30 embodiments, wherein the air filter has a MERV rating of at least about MERV 4.

In a second embodiment, the MERV rating is at least about MERV 6.

In another aspect, a first embodiment is a cleanable filter media comprising an extruded reticular structure and a silicone-based coating on the reticular structure.

A second embodiment is the first embodiment, wherein the reticular structure comprises an extruded polymer film having one or more apertures.

A third embodiment is any combination of the first two embodiments, wherein the reticular structure comprises a netting.

A 4^{th} embodiment is any combination of the first 3 embodiments, wherein the coating comprises a silicone compound having an add-on weight of about 0.5 gsm to about 10.0 gsm.

A 5^{th} embodiment is any combination of the first 4 embodiments, wherein the add-on weight is about 0.75 gsm to about 2.0 gsm.

A 6^{th} embodiment is any combination of the first 5 embodiments, wherein the silicone compound is at least about 1% by weight of a total weight of the layer.

A 7^{th} embodiment is any combination of the first 6 embodiments, wherein the silicone-based coating comprises an amino functional polydimethylsiloxane.

An 8^{th} embodiment is any combination of the first 7 embodiments, wherein the silicone-based coating comprises polyethylene glycol monotridecyl ether.

A 9^{th} embodiment is any combination of the first 8 embodiments, wherein the silicone-based coating is applied to the first or second layers by one of dip coating, rod coating, foam coating, slot-die coating, spray coating and combinations thereof.

A 10^{th} embodiment is any combination of the first 9 embodiments, wherein the reticular structure is electrically charged.

An 11^{th} embodiment is any combination of the first 10 embodiments, wherein the reticular structure is corona charged.

In another aspect, an air filter is provided according to any combination of the above 11 embodiments, wherein the air filter has a MERV rating of at least about MERV 6.

In another aspect, a first embodiment is a filter media comprising a first layer having a first air permeability and a second layer in contact with the first layer and having a second air permeability, wherein the first air permeability is greater than the second air permeability.

A second embodiment is the first embodiment, further comprising a third layer in contact with the second layer and having a third air permeability, wherein the third air permeability is less than the second air permeability.

A third embodiment is any combination of the first two embodiments, further comprising a fourth layer in contact with the third layer and having a fourth air permeability, wherein the fourth air permeability is less than the third air permeability.

A 4^{th} embodiment is any combination of the first 3 embodiments, wherein the first air permeability is about 500 cfm to about 2000 cfm at 125 Pa.

A 5^{th} embodiment is any combination of the first 4 embodiments, wherein the first air permeability is about 700 cfm to about 1500 cfm at 125 Pa.

A 6^{th} embodiment is any combination of the first 5 embodiments, wherein the first, second and third layers comprise an extruded polymer film having one or more apertures.

A 7^{th} embodiment is any combination of the first 6 embodiments, wherein the first, second and third layers comprise an extruded netting.

An 8^{th} embodiment is any combination of the first 7 embodiments, wherein the first and second layers each have one or more apertures, wherein the apertures in the first layer are at least partially misaligned with the apertures in the second layer.

A 9^{th} embodiment is any combination of the first 8 embodiments, wherein the first and second layers each comprise solid portions surrounding the apertures and wherein at least a portion of the solid portions of the first layer overlie at least a portion of the apertures in the second layer.

A 10^{th} embodiment is any combination of the first 9 embodiments, wherein at least one of the layers is electrically charged.

An 11^{th} embodiment is any combination of the first 10 embodiments, wherein at least one of the layers comprises a silicon-based coating.

In another aspect, an air filter is provided according to any combination of the above 11 embodiments, wherein the air filter has a MERV rating of at least about MERV 6.

What is claimed is:

1. A cleanable filter media comprising:
a first layer comprising an extruded reticular structure; and
a second layer in contact with the first layer and comprising an extruded reticular structure.

2. The filter media of claim 1, wherein the first and second layers each comprise one or more apertures, wherein the apertures in the first layer are at least partially misaligned with the apertures in the second layer.

3. The filter media of claim 2, wherein the first and second layers each comprise solid portions surrounding the apertures and wherein at least a portion of the solid portions of the first layer overlie at least a portion of the apertures in the second layer.

4. The filter media of claim 1, wherein the first and second layers each comprise an extruded polymer film having one or more apertures.

5. The filter media of claim 4, wherein the first and second layers comprise a material selected from the group consisting of high density polyethylene (HDPE), polyethylene, polypropylene (PP), metallocene PP, polylactic acid (PLA), thermoplastic polymers, Nylon, polybutylene terephthalate (PBT), thermoplastic elastomer (TBE), polyphenylene sulfide (PPS), polyvinylidene fluoride (PVDF), ethylene vinyl acetate (EVA), ionomers and combinations thereof.

6. The filter media of claim 4, wherein the apertures have an area of about 2500 microns² to about 4 mm².

7. The filter media of claim 1, wherein each of the first and second layers has a basis weight of about 5 gsm to about 60 gsm.

8. The filter media of claim 1, wherein the first and second layers each comprise a netting comprising strands.

9. The filter media of claim 1, further comprising a third layer in contact with the second layer and comprising an extruded reticular structure.

10. A cleanable filter media comprising:
an extruded reticular structure; and
a silicone-based coating on the reticular structure.

11. The filter media of claim 10, wherein the reticular structure comprises an extruded polymer film having one or more apertures.

12. The filter media of claim 10, wherein the coating comprises a silicone compound having an add-on weight of about 0.5 gsm to about 10.0 gsm.

13. The filter media of claim 10, wherein the silicone compound is at least about 1% by weight of a total weight of the layer.

14. The filter media of claim 10, wherein the silicone-based coating comprises an amino functional polydimethylsiloxane.

15. The filter media of claim 10, wherein the silicone-based coating comprises polyethylene glycol monotridecyl ether.

16. A filter media comprising:
a first layer having a first air permeability;
a second layer in contact with the first layer and having a second air permeability, wherein the first air permeability is greater than the second air permeability.

17. The filter media of claim 16, further comprising a third layer in contact with the second layer and having a third air permeability, wherein the third air permeability is less than the second air permeability.

18. The filter media of claim 17, further comprising a fourth layer in contact with the third layer and having a fourth air permeability, wherein the fourth air permeability is less than the third air permeability.

19. The filter media of claim 16, wherein the first air permeability is about 500 cfm to about 2000 cfm at 125 Pa.

20. The filter media of claim 17, wherein the first, second and third layers comprise an extruded polymer film having one or more apertures.
